(19) United States
(12) Patent Application Publication
(10) Pub. No.: US 2004/0024652 A1
(43) Pub. Date: Feb. 5, 2004

(54) System and method for the distribution of digital products

(76) Inventors: Willms Buhse, Hannover (DE); J. David Garland, Berkeley Heights, NJ (US); Adam Silver, New York, NY (US); Arni Sigurdsson, Ossining, NY (US); Johann Butting, New York, NY (US)

Correspondence Address: GLEN E. BOOKS, ESQ., LOWENSTEIN SANDLER PC, 65 LIVINGSTON AVENUE, ROSELAND, NJ, 07068, US

(21) Appl. No.: 10/353,470

(22) Filed: Jan. 29, 2003

Related U.S. Application Data
(60) Provisional application No. 60/399,890, filed on Jul. 31, 2002.

(51) Int. Cl. G06F 17/60

(52) U.S. Cl. 705/26

(57) ABSTRACT

In accordance with one aspect of the invention, a system for distributing digital products subject to intellectual property rights comprises a plurality of interconnected modular processing components including at least an Order Management System (OMS), an Offer Catalog Component (OCC), and a Rights Locker Component (RLC). The OMS manages the application. The OCC lists available products, and the RLC provides client branding. The components are advantageously digitally interconnected via a common messaging language. In a preferred embodiment additional modular components are coupled to additional components OMS, OCC, and RLC to encompass the full range of distribution functions.

### CROSS REFERENCE TO RELATED APPLICATIONS

This application claims the benefit of U.S. Provisional Application Serial No. 60/399,890 filed by the present inventors on Jul. 31, 2002, entitled “System And Method For The Distribution Of Digital Products”. The 60/399,890 provisional application is incorporated herein by reference.

### FIELD OF THE INVENTION

This invention relates to the commercial distribution of digital products, such as digitally encoded music, books, images, movies and games. In particular, it provides automated distribution of such products by digital processors in a secure, efficient manner. In a preferred embodiment, it envisions an automated, integrated and comprehensive system for advertising, promoting, cataloging, storing, distributing, selling and tracking the sales of such products.

### BACKGROUND OF THE INVENTION

Methods of distributing digital products have become increasingly important. Numerous products, once marketable only in tangible form, can now be digitally encoded, transmitted as digital signals and played or displayed on widely available digital machines. For example, popular songs, once distributed primarily as tangible vinyl records, can be digitally recorded, transmitted over the Internet and downloaded into MP3 players. Similarly computer software, video games, and motion pictures can be encoded, transmitted at high speed and downloaded or displayed on widely available personal computers. Indeed digitally copying, transmitting and displaying such products—which are often created at considerable expense—is seen as a threat to the copyright protection that supports the funding of their creation.

While a variety of ways to distribute digital products have been developed, none have proven completely satisfactory. For example, similar products and the necessary licenses were once transferred in tangible form, e.g. a phonograph record. But the distribution system for tangible products is inefficient, presenting the necessity of manufacturing, storing, transporting and cataloging physical products.

Intangible digital products are now commonly transmitted from a vendor's server over digital networks (wired or wireless), such as the Internet, and downloaded onto a customer's personal computer. This approach facilitates manufacture, storage and transport. But it also aggravates the problem of unauthorized copying. Moreover, many other important distribution functions—advertising, promoting, cataloging and tracking sales—are typically done on separate, independent systems. As a consequence, there is a need for systems and methods of distributing digital products with greater efficiency and security.

### SUMMARY OF THE INVENTION

In accordance with the invention, a system for distributing digital products from a client to consumers comprises one or more digital processors including a plurality of software components interconnected by a common messaging language. The basic components include a Client Interface Component accessible to clients to allow a client to set up and manage an offer of digital products for sale or subscription. An Offer Catalog Component accessible to consumers provides consumers with a listing of the products available from a client. An Account Management System processes consumer purchase orders, and a Rights Locker Component issues purchased products and associated intellectual property rights (if needed) to consumers. An Order Management System coordinates cataloging, the management of accounts and the delivery of products.

### BRIEF DESCRIPTION OF THE DRAWINGS

The advantages, nature and various additional features of the invention will appear more fully upon consideration of the illustrative embodiments now to be described in connection with the accompanying drawings. In the drawings:

FIG. 1A is a block diagram illustrating an exemplary system in accordance with the invention;

FIG. 1B is a flow chart showing an overview of system operation;

FIGS. 2A, 2B and 2C illustrate typical transactions using the system of FIG. 1;

FIG. 3A illustrates an advantageous Client Interface (CLI) for the system of FIG. 1;

FIG. 3B is a software flow chart to implement the Client Interface (CLI);

FIG. 4A illustrates an advantageous Offer Catalog Component (OCC);

FIG. 4B is a software flow chart to implement the Offer Catalog Component (OCC);

FIG. 5A is a block diagram of an advantageous Account Management System (AMS) including an Account Management Component (AMC) and an Account Management Gateway (AMG);

FIG. 5B is a software flow chart to implement the Account Management Component (AMC);

FIG. 6A illustrates an advantageous Rights Locker Component (RLC);

FIG. 6B is a software flow chart to implement the Rights Locker Component (RLC);

FIG. 7A is a block diagram of an Order Management Server including an advantageous Order Management System (OMS);

FIG. 7B is a software flow chart to implement retailer client requests in the Order Management System (OMS);

FIG. 7C is a software flow chart to implement fulfillment requests in the Order Management System (OMS);

FIG. 8A is a block diagram of an Automatic Packaging Server including an Automated Packaging Component (APC);

FIG. 8B is a software flow chart to implement the Automated Packaging Component (APC); and,

FIG. 9 is a block diagram of an advantageous Data Reporting Component (DRC).

### DETAILED DESCRIPTION

This description is divided into two parts. Part I is an overview of an exemplary system in accordance with the invention, and Part II describes advantageous components for the system.

I: Overview of the System

Applicants' invention provides a comprehensive distribution system for clients who would sell digital products, especially intangible digital products that can be delivered as a flow of digital signals and digital products subject to intellectual property rights. Applicants' system can provide each client with a virtual store such as a branded website. The system can store the client's digital products, provide a virtual catalog of the client's products and, upon the client's request, transmit the products to the client's customers subject to client-prescribed rights. Clients can include content providers, distributors and retailers.

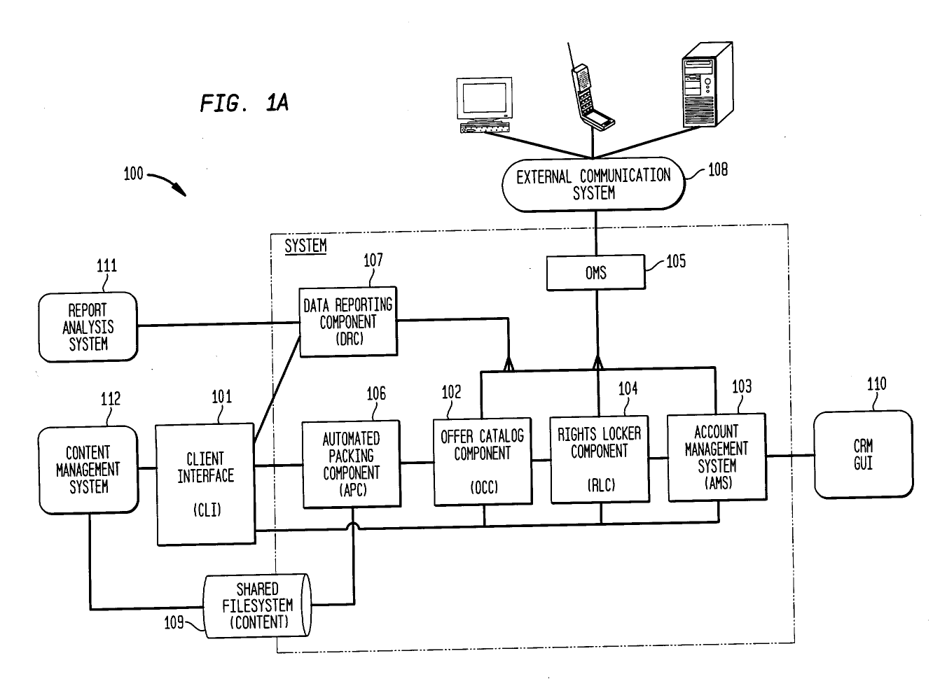

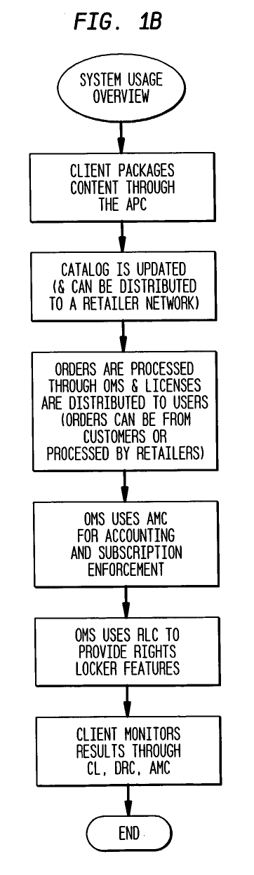

Referring to the drawings, FIG. 1A is a schematic diagram of an exemplary system 100 for the distribution of digital products. The basic functional modules of a preferred system 100 comprise a Client Interface 101, an Offer Catalog Component 102, an Account Management System 103, a Rights Locker Component 104 and an Order Management System 105. Additional useful components include an Automated Packaging Component 106 and a Data Reporting Component 107. Each component comprises a modular software component, and the system 100 comprises one or more digital processors including the modular components interconnected by a common messaging language.

In essential operation of the system 100, the Client Interface Component 101, accessible by clients, allows each client to set up and manage its offer of digital products for sale or subscription. The Offer Catalog Component 102, accessible by customers, provides customers with a listing of the digital products available from each client. The Account Management System 103 processes consumer purchase orders for each client and communicates the orders to the client (or to prescribed software). Purchase orders can include downloads, subscriptions, and promotions. In response to the client or prescribed directions, the Rights Locker Component 104 issues purchased products to the customer. The Order Management System 105 coordinates the cataloging of products, the management of accounts and the delivery of products to consumers.

The Client Interface 101 allows a client to package content via a Content Management System 112. It can also permit the client to manage its offer catalog, administer subscription plans and report rights clearing. The Content Management System 112 can comprise a 3^{rd} party plugin.

The Offer Catalog Component (OCC) 102 can be a real time listing of available digital products. OCC 102 sends product IDs to the system as well as confirming whether or not a product is a part of a subscription plan. Catalogs can be created for individual distributors.

The Account Management System (AMS) 103 processes consumer purchases and subscriptions. It stores information such as consumer IDs, purchased product, and pricing. It creates and administers subscriptions and the business models for those subscriptions. The AMS 103 is advantageously integrated with a Customer Relationship Management Graphical User Interface (CRM/GUI) 110. Here the CRM/GUI 110 provides customer care interfacing, customer profiling, recommendations and personalization.

The Rights Locker Component (RLC) 104 is the client's branded customer interface. It is a web site with the client's branding. Through this interface, the client can transfer rights for consumers to use a digital product to wireless, handheld, cable, or other devices. The RLC has the ability to handle multiple copies for a consumer and to allow the registration of multiple devices by a consumer. It can also administer volume licensing for tracking the usage of multiple consumers. Business rules for administering these rights can be set by the client or by a 3^{rd} party.

The Order Management System (OMS) 105, is essentially an event driven command processor that manages the entire application. External communications 108 to the application are routed through OMS 105 to the appropriate functional module. OMS 105 reacts to requests from both external and internal interfaces.

The Automated Packaging Component (APC) 106, packages a digital product for shipment (transmission) by encrypting it with any known digital rights management technology. The product can be made available to a customer via a fire sharing system 109.

The Data Reporting Component (DRC) 107 generates real time and batch reports of sales figures, content activity, billing, user/download rights, and other types of system reports. The client can interact with DRC 107 through a website interface.

FIG. 1B is a schematic flow chart showing an overview of essential system operation. A client packages digital content through the APC 106. The system then updates the catalog and the catalog can be distributed to a retail network. Orders placed by retailers, by retailers for consumers, or placed directly by consumers are processed through the OMS 105. The OMS uses the AMC 304 (part of the AMS 103), for accounting and subscription enforcement. OMS uses RLC 104 to provide intellectual property rights and security features. And finally, the client monitors the results of sales transactions through the CLI 101, DRC 107, and AMC 304.

The advantages of the system architecture are manyfold. The system of FIG. 1 can integrate into a single system all of the processes of digital information distribution, from content preparation to subscription administration, end-user rights management and cross-platform download management. The system can provide a complete solution for account management (including subscription plans), packaging (encrypting content with business and content rules), catalog aggregation and content management, storefront and shopping cart (supports integration with affiliate sites), rights locker (online storage and maintenance of customer rights), and complete reporting.

The system architecture is component-based. Each component is a functional part the system that accomplishes well-defined tasks. Each component acts according to incoming messages, and transmits the functional results of those tasks via outgoing messages. Components send and receive messages from other components even if they are not directly connected to each other. Component tasks once established, are definite. Similarly, communications paths, can be established and fixed. A usable configuration can reside on any type of computer, or across several computers on a network, because in the system can be platform independent.

The system architecture also allows implementation of only needed functionality. The modularity allows for upgrading of code and features. Additional commercial technologies can be seamlessly integrated into the system without affecting other parts of the system. The system can use proven industrial standard technologies for internal components. Java, C++, XML, RMI, HTTP, Oracle, MS SQL, Windows 2000 and Solaris can deliver a stable and reliable system for large-scale transaction processing and customer interaction. The system architecture is also believed to be compatible with future standards being developed for digital rights management such as rights languages.

The system functions as one integrated package comprised of components. A common messaging scheme ties it together. All components communicate via the same messaging language which can be a software language that is platform independent. In practice, a system is physically implemented on a defined platform under one or more types of operating systems. The components are then compiled for that operating system from source files in one or more languages appropriate to the chosen platform or platforms. Typical platform operating systems include: Windows, LINUX, Java, Sun OS, Solaris, BREW, and UNIX.

Components that interface to 3^{rd} party commercial software translate system messages to the appropriate communications for those system interactions. Similarly, interactions with consumer web access points 108, including mobile phones, personal digital assistants (PDA's) and personal computers, are converted into system messages. Consumer web access platforms typically run Windows, LINUX, Apple OS, Mac OS, Palm OS, versions of PocketPC, and other proprietary operating systems.

Communication is accomplished internally via native interfaces, and externally through the use of abstracted communications interfaces, or adapters. The term abstracted refers to a translation scheme to translate system messages as between the system, and third party systems and components, in both directions. Internal communication can occur via RMI, ODBC/JDBC, SOAP, or XML. External communication can occur through the used of adapters which act as middleware. XML messaging via http can be used to enable communication and easy integration with existing systems without major modification to either system.

The system internals are transparent to the customer who makes a purchase from a client branded website. A key feature of the distribution system is its ability to simultaneously manage the cataloging and distribution of the digital product along with its legal use rights. But, digital rights management (DRM), while an important aspect, is only one part of the system. The system can function with existing DRM schemes.

The system is DRM Independent. It allows for the integration of new DRM technologies with minimal effort. Typical examples of existing DRM technologies are commercial products offered by Adobe Content Server, Microsoft and TryMedia. The system rights (various types of IP use authorizations made by the system) are DRM technology neutral. This allows the Consumer to have content portability across different devices and device types (e.g. portable encoded media play back devices, such as MP3 player's, cell phone, PDA's and PCs) and manage it all in one system.

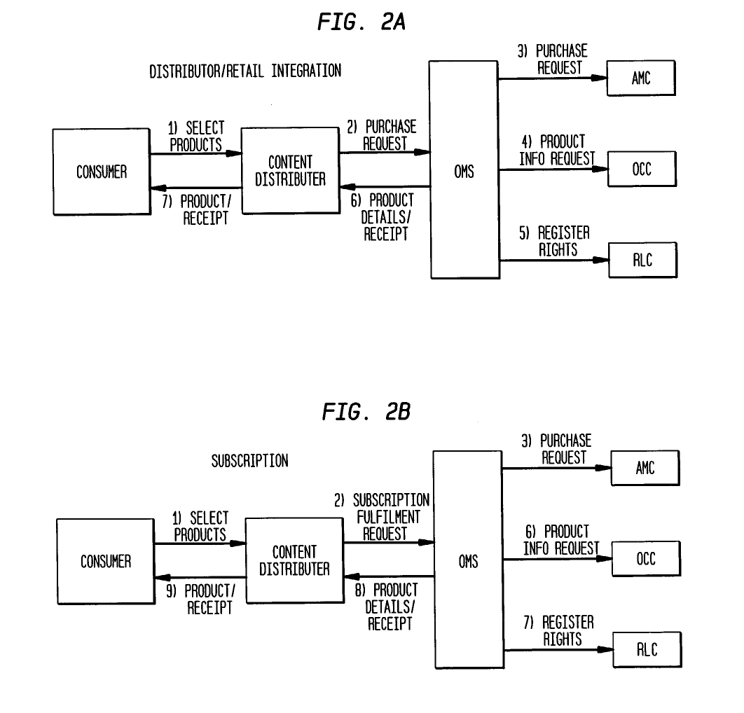

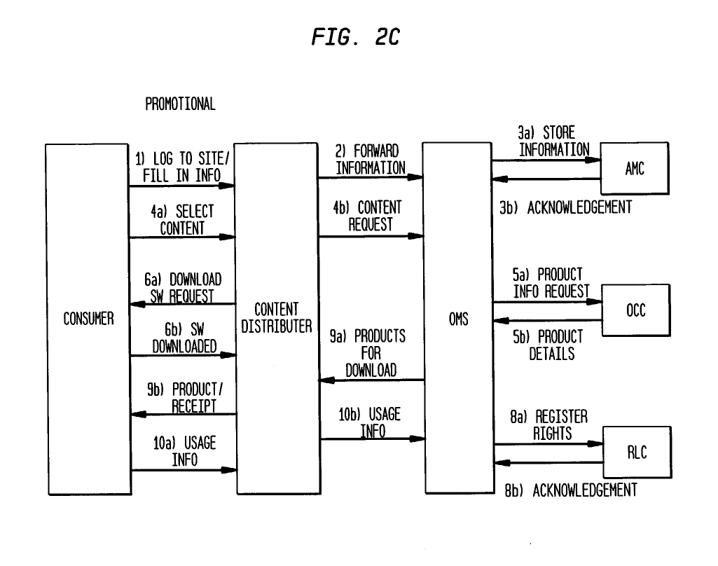

The operation of the system can now be more clearly understood by consideration of three exemplary transactions illustrated in FIGS. 2A, 2B and 2C.

FIG. 2A illustrates a Distributor/Retail Integration scenario wherein a consumer purchases a product and a distributor tracks the sale.

1. The Consumer purchases a digital product from a Content Distributor website, adds the product to a shopping cart, and checks out after providing payment information. The Distributor performs financial clearing.

2. The Distributor system sends a purchase request to the OMS 105 for the digital products in the order.

3. The OMS 105 accepts the request and forwards it to the AMS 103 for further processing.

4. The OMS 105 requests product information from the OCC 102.

5. The OMS 105 sends a rights update request to the Rights Locker 104 and sends a purchase response to the Distributor.

6. The Distributor website receives the purchase response, and

7. forwards the product and receipt to the Consumer.

FIG. 2B illustrates a subscription scenario wherein a digital subscription plan is offered to a consumer.

1. The Consumer visits a retail website or a Rights Locker website to view the subscription plan (playlist) and selects tracks to download.

2. The Content Distributor site sends a subscription fulfillment request to the OMS 105.

3. The OMS 105 retrieves subscription plan information from the AMC 304 (a component of the AMS 103) for the Consumer account.

4. The AMC 103 checks if there are available slots for download.

5. The OMS 105 retrieves the plan's product information from the OCC 102.

6. The OMS 105 forwards the product information to the RLC 104, which stores the account information and the Consumer's rights to the slots. The RLC 104 updates the rights information.

7. The OMS 105 sends a subscription fulfillment response containing product information to the Distributor who forwards it to the Consumer.

8. The Consumer receives the product/receipt and downloads the content. The rights are requested for each slot from the OMS 105.

FIG. 2C illustrates a promotional scenario wherein a consumer receives a digital product at no cost in exchange for leaving valuable user information.

1. The Consumer logs in using the promotion ID.

2. The Consumer selects the product to be downloaded and submits the request for content (4a).

3. The OMS 105 retrieves product information from the OCC 102 (5a).

4. The Consumer is prompted to download software needed to play the content. (For example, a player or DRM-specific software) (6a).

5. The OMS 105 updates the RLC 104 with the new content/rights (8a).

6. The OMS 105 updates the promotion site, and the selected products are downloaded to the Consumer device (9b).

7. When the Consumer plays the content, usage information is sent to the OMS 105 (10a, 10b).

The system integrates with existing ‘shopping carts’ to allow mixed physical and digital orders in the same shopping cart. A retail consumer can typically access the system by telephone, computer, cell phone, PDA, or other mobile device. And, the system can handle multiple languages and currencies to support the global demands of Internet offerings. All internal character sets advantageously support 16-bit Unicode or its equivalent.

Part II: Detailed Description of Advantageous Components

We now describe in greater detail the structure, operation and interconnections of a set of preferred modular components for implementing the system of FIG. 1. Each component of the system is first discussed generally in terms of its functionality and interconnection to the rest of the system. Then a flow chart representation of the component is presented for an exemplary algorithm, stored on a digital media such as computer hard drive, to perform the function of the component on a digital computer. Finally, we present a list of exemplary system messages and requests that allow the component to communicate with other components to act in concert in the system.

A. Client Interface (CLI)

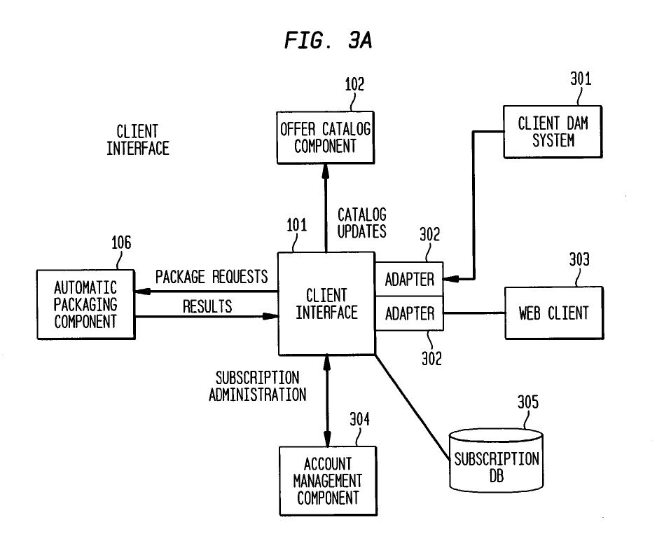

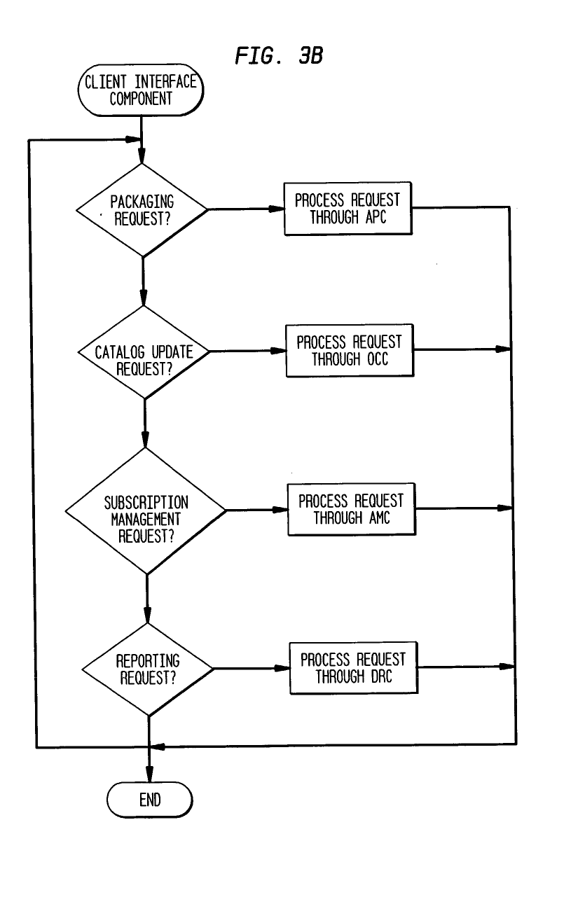

FIG. 3A schematically illustrates in context an advantageous Client Interface (CLI) 101. The CLI 101 is primarily an interface between clients and the system. The inputs are offers, content packaging rules, and subscription plans. The outputs are system reports. The CLI is an algorithm in software programmed on a digital computer that acts as a CLI web interface and gateway for the content provider into the system. The CLI is connected to AMC 304, OCC 102, and APC 106.

The CLI 101, interfaces the content provider to the rest of the system. A web interface is provided, allowing browser-based content management. In addition, a customizable interface can be provided for direct connection to content provider systems such as Digital Asset Management (DAM) systems 301. A web client 303 is connected to the CLI via adaptor 302.

CLI 101 provides four functions to the client: content packaging, offer maintenance, subscription plan maintenance, and clearinghouse reporting. The CLI delegates packaging requests to the APC 106. The APC 106 notifies the CLI of successful packaging operations, and the CLI then updates the OCC 102 with the new offers. The CLI communicates with the OCC 102 through a real time interface for both packaging and offer updates.

In addition to receiving the content, CLI 101 can receive the following packaging information of the client: business rules including distribution rules and transaction time rules; metadata for inclusion in the package and Offer Catalog and retail channel information including retailers allowed/disallowed, and territorial restrictions. The CLI also communicates with AMG 501 for subscription plan maintenance. AMG 501, in turn, communicates with AMC 304 to edit plans. Alternatively as shown in FIG. 3, the CLI can communicate directly with AMC 304.

CLI Flowchart:

FIG. 3B is a flow chart of an exemplary algorithm to perform the CLI function. The CLI algorithm is a continuous loop, processing requests from clients of the system. A graphical user interface is presented to the client for each of the operations below.

Packaging requests are passed to the Automatic Packaging Component for processing, and results are returned to the client.

Catalog update requests are passed to the OCC 102, and the result is returned to the client.

Subscription management operations are processed through the AMC. These operations allow a client (affiliate) to create custom subscription plans based on their own business rules.

Reporting requests are processed through the DRC, with the results presented to the client by the CLI.

CLI Messages and Requests:

The CLI can typically support the following messages and requests:

Account Management: The OMS 105 requests the creation, update, or deletion of an account.

Purchase Request: The OMS 105 specifies the details of a purchase.

Subscription Purchase: The OMS 105 specifies the details of a subscription purchase.

Subscription Fulfillment: The OMS 105 specifies the details of a subscription fulfillment request. OMS 105 fulfillment is subject to AMC 304 approval, based on the business rules of the specific subscription plan in effect.

Subscription Status Request: OMS 105 requests details on a specific subscription account.

Catalog Maintenance: CLI 101 requests of OCC 102 the creation, update, or deletion of catalog entries.

Catalog Edit/Update: CLI 101 requests copies of a given Client's catalog for editing in a CLI 101 session. The updated catalog is then sent to OCC 102 to be reincorporated into the main catalog.

Account Maintenance: CLI 101 requests of AMG 501 the creation, update, or deletion of a consumer account (as a CRM operation).

Subscription Plan Maintenance: CLI 101 requests of AMG 501 the creation, update, or deletion of a subscription plan.

Rights Locker Account Maintenance: CLI 101 requests of RLC 104 the creation update, or deletion of a rights locker account (as a CRM operation).

Report Request: CLI 101 requests a report of the DRC 107

Report Maintenance: CLI 101 requests of DRC 107 the creation, update, or deletion of a report type.

An associated Subscription Database 305 contains Consumer account information necessary to support account management, subscription support, CRM, financial clearing, and reporting.

B. Offer Catalog Component (OCC)

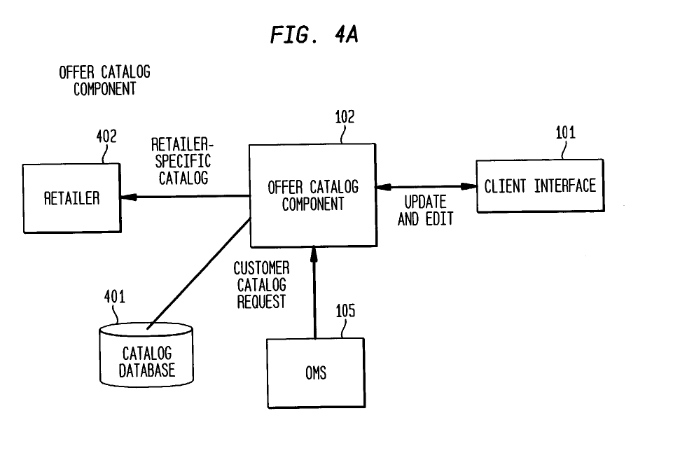

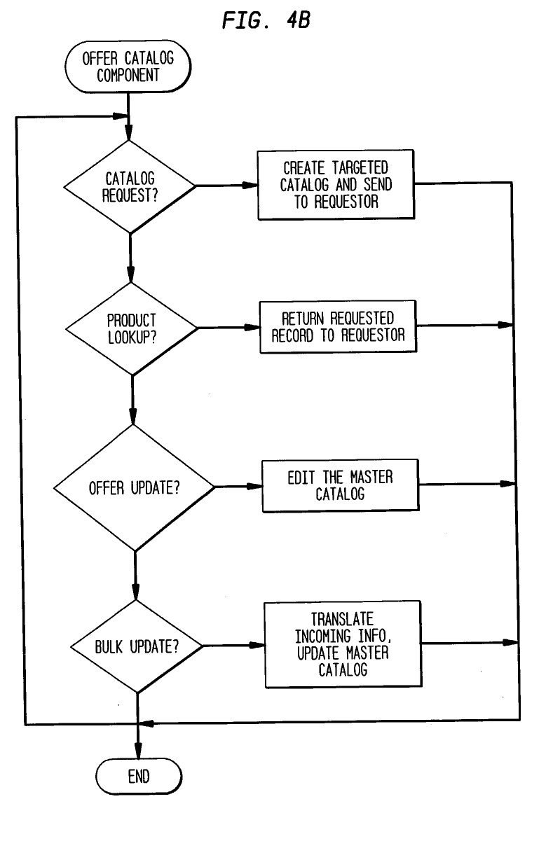

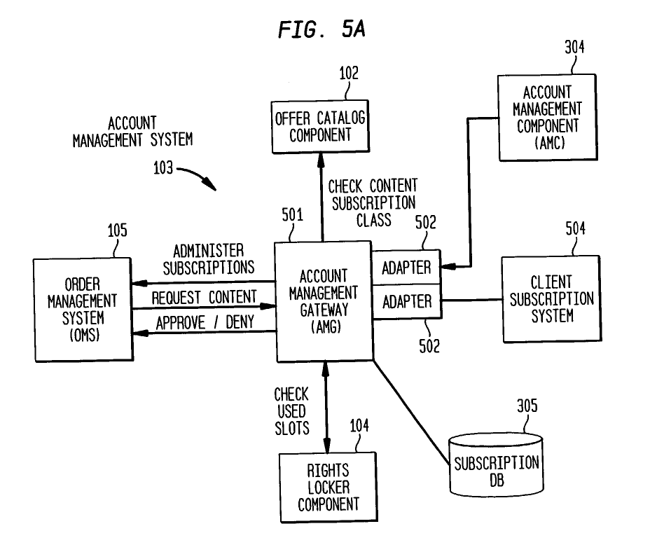

FIG. 4A schematically shows an advantageous Offer Catalog Component (OCC) 102 in relation to other components in the system 100. The OCC 102 maintains the content catalog database 401 that contains product and offer information for supported digital content. The OCC can provide a real-time listing of digital content products available through the system. The OCC also provides information about the product content. The digital products listed in the OCC can be stored elsewhere. The OCC can work in conjunction with 3rd-party providers of promotional catalogs and facilitate their integration to provide updated digital catalogs.

The OMS 105 can send product information requests to the OCC 102 for specified product IDs. The OCC can then look up the information in the database and send the product information back to the OMS 105. For example, the OCC can report whether the product belongs to a subscription plan or not. The OCC can also receive product and offer information from external systems in proprietary formats. A custom filter reformats the data into the system's internal format. The OCC can be updated as the result of a packaging operation or an offer catalog change.

The OCC 102 can create catalogs for individual distributors using a table-driven mechanism. The, resulting catalogs can be sent via FTP under distributor accounts with login/password protection. Other distribution means can be supported according to customer requirements.

The product information requests that the OCC 102 supports may use external product IDs from 3rd-party catalog aggregators of music and publishing, such as Muze. The OCC can provide an abstract interface to such services and a connector to each specific service.

The inputs to the OCC 102 include retailer catalog uploads, customer requests for product, pricing, and subscription information. Access can be made directly to the OCC by external connections to the Web or by queries routed through the OMS 105. The OCC can be tied directly to the catalog database 401 where catalog information is stored. Outputs include results of product queries, retailer specific complete catalogs, and catalog information related to a purchase. Purchase related information can be sent directly through OMS 105. The OCC is an algorithm in software programmed on a digital computer. It executes database maintenance operations including uploading, editing, deleting, and database query processes. Statistical information on catalog requests including frequency of queries per product can be collected and stored in the OCC. A daily process can be run to remove expired offers from the Catalog Database 401.

Information comes into the OCC 102 from the CLI 101. The OCC receives product and offer information in several ways: Clients feed the OCC in their proprietary formats, a custom filter reformats the data into the system's internal format, third-party catalog providers provide cross-referencing information, and clients the OCC is updated as the result of a packaging operation or catalog offer updates.

On the distribution side, the OCC 102 can create catalogs for individual retailers using a table-driven mechanism. The resulting catalogs can be made available under retailer accounts by FTP with login/password protection. Other distribution, approaches can be supported according to customer requirements.

Product information requests from internal system components can use external product IDs, such as those of Muze, AMG 501, or a client's proprietary system. The Offer Catalog Component has an abstract interface to such services and a connector to each specific service.

A numbering scheme for DRM versions can be provided for internal use. Product entries in the catalog specify a number range of valid DRM versions, e.g.: 10.31 to 10.76 might indicate MS WMA, versions 6.0 through 7.1. Packaging for a newer, incompatible version is assigned a new product number and DRM range. As new DRM versions are released, the catalog ranges are changed as appropriate. OMS 105 uses the DRM version in generating the correct key for the particular package.

OCC Flowchart:

FIG. 4B is a flow chart of an exemplary algorithm to perform the OCC function. The OCC is a continuous loop, processing requests from other components.

Catalog requests (from OMS) cause the OCC to create a targeted catalog based on the ID of the client. An internal table can specify what catalog data each requester receives, e.g.: music only.

Product lookup requests (from OMS, RLC, AMC, or CLI) cause the OCC to look up and return requested records. This information is used internally for fulfilling orders and maintaining accounts. In addition to system product IDs, 3rd-party catalog IDs may be used. The OCC internally cross-references these identification codes.

Offer update requests (from clients via the CLI) edit the catalog.

Bulk update requests can merge a large client catalog update with the OCC catalog.

OCC Messages and Requests

The OCC can advantageously support the following messages and requests:

Catalog Update: provides for the bulk loading of catalog information, and for editing and deleting entries.

Create Catalog: provides for the creation of a retailer-specific catalog.

Product Info Lookup: allows other components to access catalog information.

Client-specific catalog create/load: allows CLI 101 to retrieve a client's catalog for edit, and then, after edit, to reincorporate it into the OCC.

C. Account Management System (AMS)

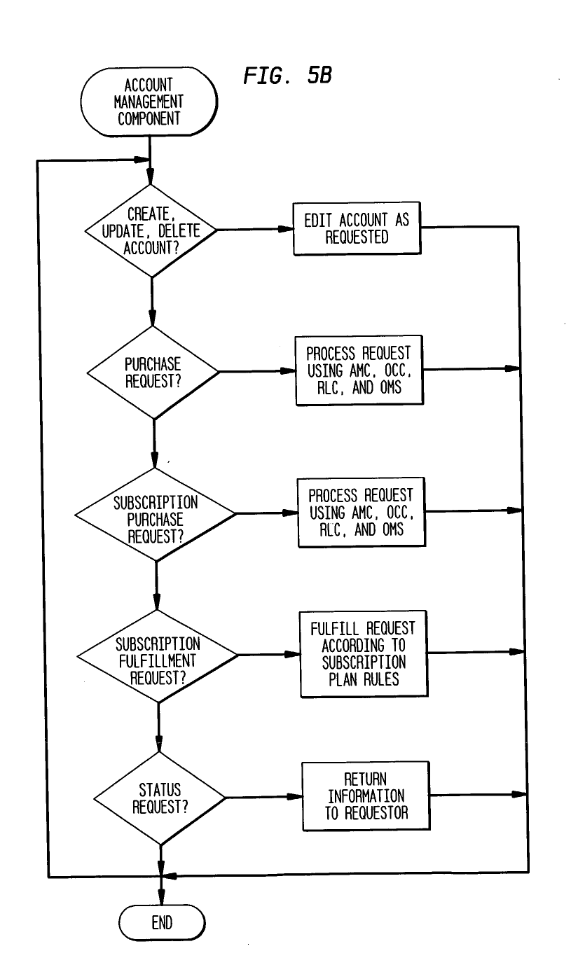

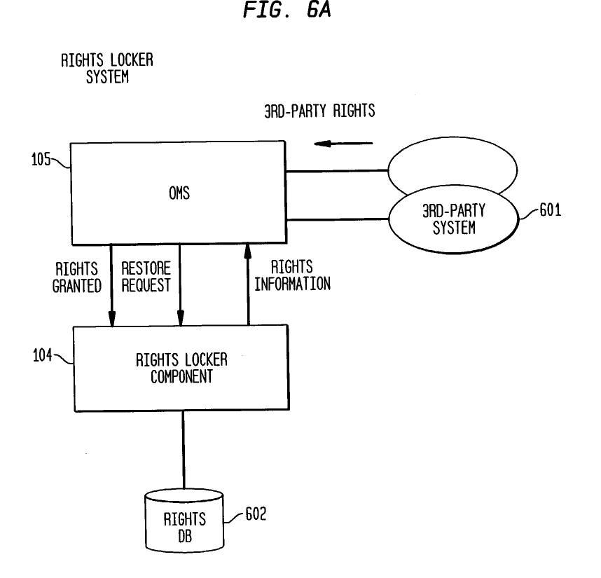

FIG. 5A schematically illustrates in context a preferred Account Management System (AMS) 103 composed of an Account Management Gateway (AMG) 501 and an Account Management Component (AMC) 304. The AMG 501 serves as a bridge between the AMC 304 and the rest of the system. The AMG inputs include subscription information, requested content information, and catalog information. The outputs include subscription status, account maintenance information, and other information sent to the OMS 105. The AMG is an algorithm in software programmed on a digital computer that serves as a gateway for client customized use of the AMC 304. The AMG is connected to the OMS 105, the subscription database 305, the AMC 304, and the OCC 102. It can also be connected to the CLI 101.

The Account Management Gateway (AMG) 501 provides an abstract interface between the system and the Account Management Component (AMC) 304 via adapter 502. This interface isolates the system from changes in the AMC 304, prevents system-specific changes to the AMC 304, and allows multiple Account Management Components.

The second main component of the AMS is the Account Management Component (AMC) 304. The AMC is an online subscription and account management system. It stores information about consumer accounts, and creates and administers subscription plans, as well as enforcing the business rules of subscription plans.

The AMC 304 processes Consumer purchases and subscriptions. It can store Consumer purchase information, typically including: Consumer ID, purchased product, pricing, and more. The AMC processes initial account registration, update, renewal, suspension and auto-renewal for each Consumer or Client. It also can handle order cancellation for either subscriptions or purchases.

The AMC 304 sends the subscription account information to the OMS 105. For subscription purchases, it manages flexible business rules including time-based, group-based, quantity-based and other customized subscription models. The AMC is capable of processing account financial clearing, if necessary.

The AMC 304 is a centralized location for managing account information. It is capable of managing complex subscription plans. Via the AMG 501, the system can integrate multiple account management systems, allowing the support of existing customer subscription management and accounting systems. The Client maintains full ownership of existing accounts and the associated data. The client or system manager receives only a Consumer ID number. The AMC manages the entire subscription system.

The inputs to the AMC 304 are customer identification and account information, requests to create edit or delete customer accounts, subscription purchase, edits, or cancellations, and records of purchased products along with product information typically including pricing information. All inputs can be provided to the AMC via the Account Management Gateway. The AMC can be an algorithm in software programmed on a digital computer that executes database type storage an retrieval operations. Optionally, the AMC utilizing heuristic methods, such as fuzzy logic, can develop and report customer preferences and buying patterns. Outputs can include customer data, customer purchase statistics and preferences, subscription information, and purchase details.

The Account Management Component (AMC) 304 contains the business logic of the subscription offerings according to the client subscription system 504 via an adapter 502, and maintains the status of each subscribed consumer. The AMC can be implemented using a 3rd-party product such as Sandlot EclipseNet.

AMC Flowchart:

FIG. 5B is a flow chart of an exemplary algorithm to perform the AMC function. The AMC processes requests through the Account Management Gateway (AMG). The AMG isolates changes in AMC from the rest of the system, and allows supporting client-owned accounting systems, if required, without changing the system architecture.

Requests to create, delete, or update an account are processed internally by the Account Management Component. This process maintains the end-user accounts serviced by the system.

Purchase and subscription requests, and subscription fulfillments, are internally processed by the AMC. The AMC indicates to the requestor (normally OMS) whether the account holder is authorized to have the requested content. The business rules associated with the content and for the corresponding client, e.g.: content provider, are maintained within AMC.

AMS Messages and Requests

The AMG typically supports the following messages and requests:

Account Management: The OMS 105 requests the creation, update, or deletion of an account.

Purchase Request: The OMS 105 specifies the details of a purchase.

Subscription Purchase: The OMS 105 specifies the details of a subscription purchase.

Subscription Fulfillment: The OMS 105 specifies the details of a subscription fulfillment request. OMS 105 fulfillment is subject to AMC 304 approval, based on the business rules of the specific subscription plan in effect.

Subscription Status Request: The OMS 105 requests details on a specific subscription account.

Account Maintenance: The CLI 101 requests the creation, update, or deletion of a consumer account (as a CRM operation).

Subscription Plan Maintenance: The CLI 101 requests the creation, update, or deletion of a subscription plan.

The AMG 501 also requests information of the Offer Catalog Component on behalf of the AMC 304, and supports a Product Info Lookup Request to OCC 102.

For account status requests, the AMC retrieves account-holder records, and returns the result to the requester.

The AMC advantageously supports the following messages and requests:

Account Management: The OMS 105 requests the creation, update, or deletion of an account.

Purchase Request: The OMS 105 specifies the details of a purchase.

Subscription Purchase: The OMS 105 specifies the details of a subscription purchase.

Subscription Fulfillment: The OMS 105 specifies the details of a subscription fulfillment request.

Subscription Status Request: OMS 105 requests details on a specific subscription account.

An associated Subscription Database 305 contains all Consumer account information necessary to support account management, subscription support, CRM, financial clearing, and reporting.

D. Rights Locker Component (RLC)

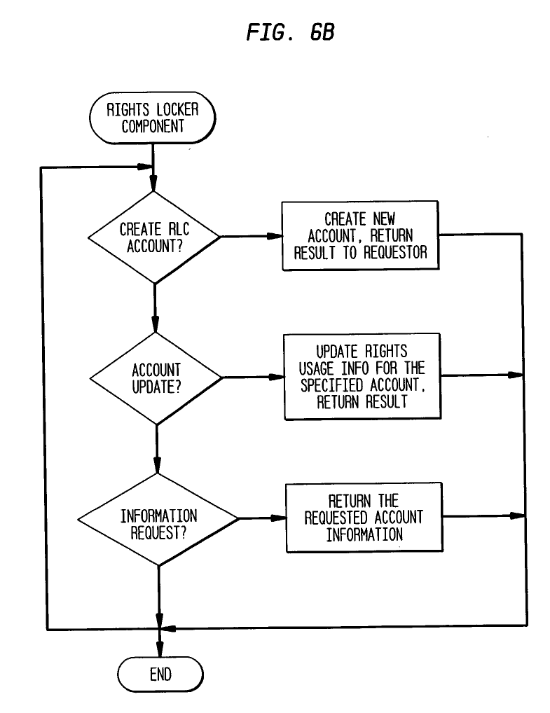

FIG. 6A is a schematic diagram showing an advantageous Rights Locker Component (RLC) 104 in relation to other system components. The RLC 104 is a central repository for consumers to access their purchased or promotional content rights from anywhere through a web interface that can be client-branded. The RLC provides mobility for the user to transfer content rights between PC's and other outlets such as wireless, handheld, cable, and other fixed and portable devices.

The rights information can be viewed on a Rights Locker access interface 601, such as a website, through OMS 105. The Rights Locker website can advantageously be client branded, so that the experience is transparent to the consumer. The client thus maintains ownership of the consumer relationship. The consumer determines which rights to transfer to other devices, according to client business rules. The RLC 104 provides the consumer with a backup for the recovery of active rights, avoiding help desk reset requests.

The Rights Locker Component (RLC) 104 maintains a Rights Database (RDB) 602, which contains rights information for each Consumer. The stored information can include products purchased and rights granted (e.g. start and stop date, burn-to-CD and download-to-PDA privileges, DRM used, and number of devices permitted and used).

The RLC 104 communicates with the OMS 105 for saving and restoring rights. The OMS 105 sends update rights requests to the RLC 104 and receives rights status responses. The OMS 105 notifies the RLC 104 when rights are granted or side-loaded. (Side-loaded rights are digital rights to purchased content). The OMS 105 also notifies the RLC 104 when a purchase is canceled, such as for the return of a digital product. Following such a return, the money is issued back to the consumer and the previously granted rights are deleted. The RLC stores the rights by account number in the Rights Database (RDB) 602. In response to a Rights Restore message from the OMS 105, the RLC returns the information necessary to generate rights for sending to the Consumer.

The inputs to the RLC 104 are the rights which have been granted to the Consumer from a current or past purchase where the rights are still valid, the consumer's identification information, and any deleted rights due to canceled sales, returns, or expiration of rights. The RLC can be an algorithm in software programmed on a digital computer making use of the RDB 602. It processes rights actions or requests to generate rights storage or rights actions, such as granting a particular right to use a digital platform or not. The RLC outputs are rights records to be saved, deleted, or edited on the rights database 602, and rights grants or denials. The RLC is directly connected to the OMS 105 and communicates with the system, the Client, and Consumer through OMS 105. The RLC is also directly connected to the RDB 602.

The RLC 104 (and OMS 105) can advantageously record consumer preferences. This information can be provided by the retailer for recording in the RLC. A fuzzy logic matching capability in conjunction with catalog searches can make helpful product suggestions and help direct the consumer. In addition, a central play list store allows the consumer access to their personal play lists from any device, as well as play list sharing operations through OMS 105.

The rights locker can also integrate with 3^{rd} party locker systems. Additionally, the system can support rights expression languages such as the Open Digital Rights Language (ODRL) and eXtensible rights Markup Language (XrML) in order to facilitate DRM neutral packaging processes and the transfer of rights between different DRM platforms.

RLC Flowchart:

FIG. 6B is a flow chart of an exemplary algorithm to perform the RLC function. The RLC processes requests from other components.

In response to a create request, the RLC creates a new end-user RLC account using the account ID provided.

In response to an account update request, the RLC edits the specified user account, updating the rights usage information with the supplied data.

In response to a rights information request, the RLC returns the specified user account information to the requestor.

RLC Messages and Requests:

The RLC typically supports the following messages and requests.

Update Rights: The OMS 105 updates the RLC 104 with the details of a rights transaction. This can be the result of a retailer purchase, secondary rights generation, or a 3rd-party update (e.g.: side-loaded rights from a physical retailer).

Request Rights: The OMS 105 requests information necessary to generate secondary rights.

Create Rights Locker Account: OMS 105 requests the creation of an account on behalf of a consumer.

Rights Locker Account Maintenance: CLI 101 requests of RLC 104 the creation, update, or deletion of a rights locker account (as a CRM operation).

E. Order Management System (OMS)

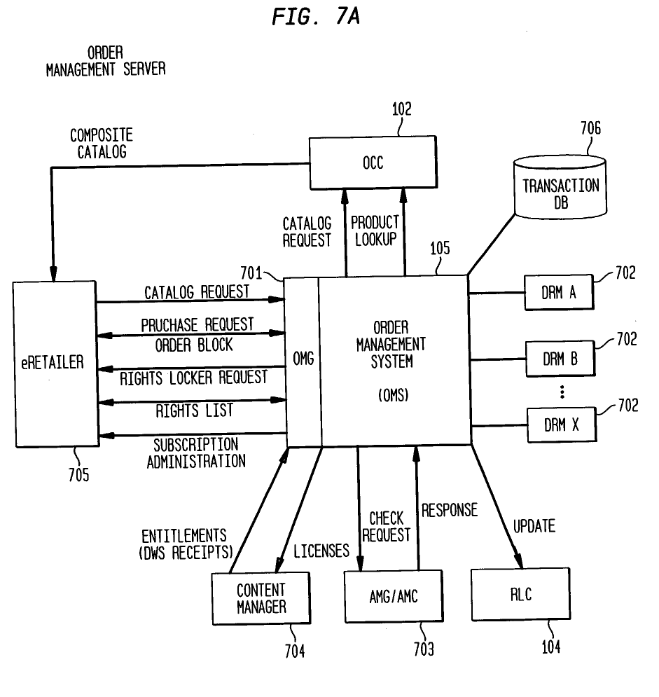

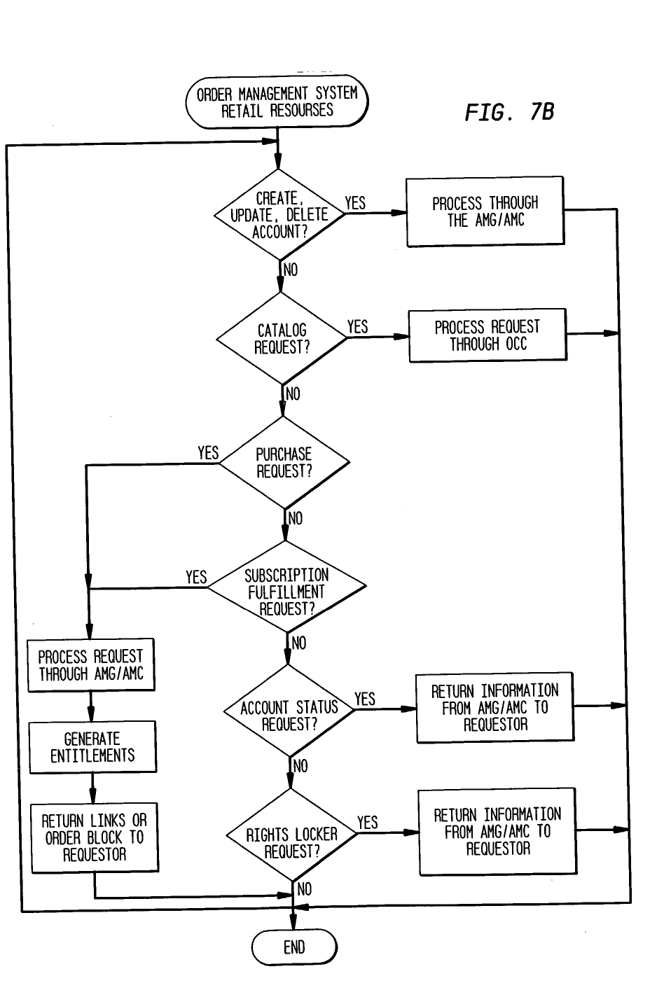

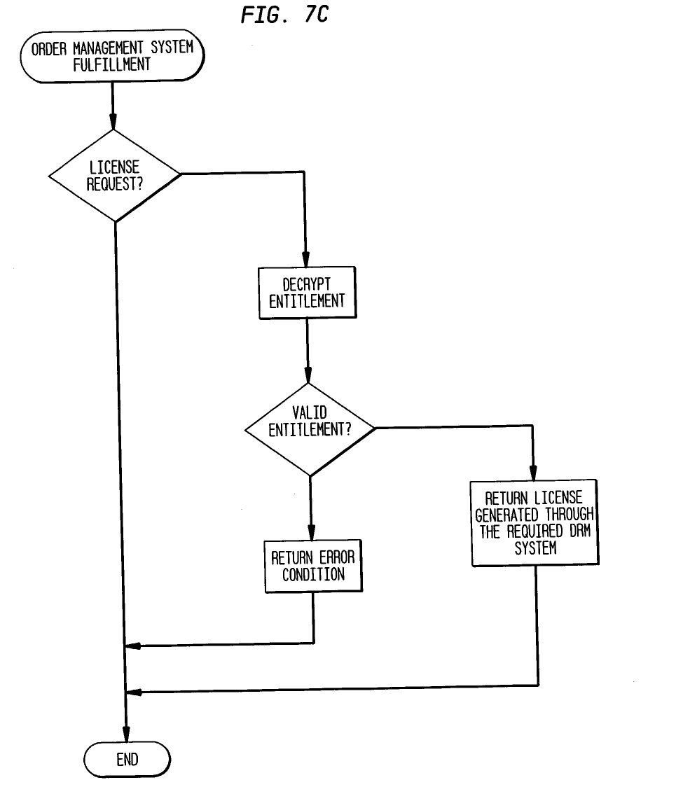

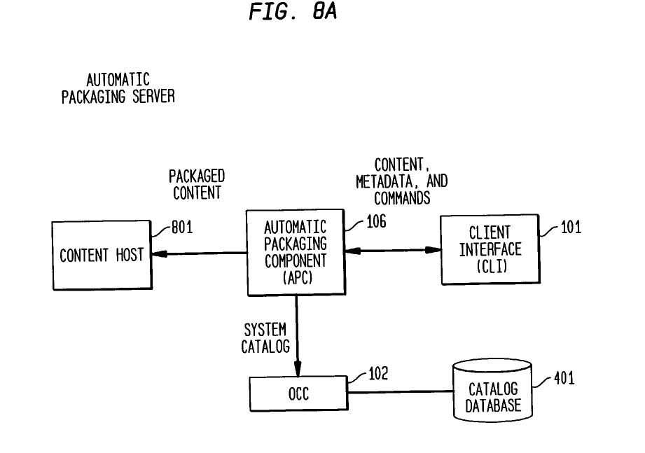

FIG. 7A is a schematic diagram showing an advantageous Order Management System (OMS) 105 in the context of an order management server and its relation to other systems components. The OMS manages all communication to the client and the consumer and handles all internal system communications. The OMS is internally connected to the other components via the internal and external messaging system as previously described. The OMS 105 is internally connected to the OCC 102, Transaction database 706, one or more digital rights management modules 702, the RLC 104, AMG/AMC 703, and the content manager 704. The OMS is externally connected via the OMG 701 to a Client using external communication protocols. The inputs to the OMS are queries, commands, replies, requests for data and data reports and the replies to those requests. The OMS can access any part of the system directly or through a system gateway. Messages are sent to and directed by the OMS. The OMS is an algorithm in software programmed on a digital computer and serves as the overall processor for most of the system processes and functions.

The Client sees the OMS 105 as the mechanism delivering rights to the consumer, sending confirmations, and managing rights updates. Internally, the OMS acts as a turnstile, receiving messages and forwarding messages. Messages are now the system components communicate with one another. All external communications come first to OMS, which parses each message and forwards it to the appropriate component for further processing.

The OMS 105 is an event-driven command processor driven by requests from either external or internal interfaces. The OMS can receive requests from an external e-retailer site 705 and send confirmation notifications and responses. For each request, the data includes a retailer ID and product ID. The OMS can also maintain a Transaction Database 706 which is a central store of all transactions performed by the system.

The OMS 105 is composed of an overall framework and a DRM-abstraction layer. The various DRM technologies 702 are interfaced through individual connectors. Examples of supportable technologies are: Microsoft, Adobe Content Server, and TryMedia.

The Order Management Gateway (OMG) 701 is provided between OMS 105 and a client such as retailer 705. In cases where a custom interface is needed, the translation is performed in OMG, thus protecting OMS 105 from changes in outside systems. Additionally, load-balancing tasks may be performed in OMG 701. The OMG accesses Content Manager 704.

The OMS 105 manages messages from a variety of information sources. It can use XML to connect to external systems and to quickly process a plurality transactions. It also handles the initial sorting.

The OMS 105 can be driven by client requests. It records all requests in the Transaction Database (TDB) 706. In fulfilling requests, the OMS communicates with the OCC 102, RLC 104, and Account Management Component (AMC) through the Account Management Gateway (AMG) 703 for catalog, rights locker, and account processing.

OMS Retail Client Request Flowchart:

FIG. 7B is a flow chart of an exemplary algorithm to perform the OMS retail client request function. The OMS Retail Request Processor continuously monitors for commands from distributors (retailers).

Requests to create, delete, or update an account are processed through the Account Management Gateway/Account Management Component (AMG/AMC). This process maintains the end-user accounts serviced by the system.

Catalog requests are processed through the Offer Catalog Component. Catalog delivery is handled by the OCC 102.

Purchase requests and subscription purchases are first processed through the AMG/AMC. The AMC indicates to OMS whether the account holder is authorized to have the requested content. If so, OMS generates the entitlements for the indicated content, and returns the result to the requestor. The result returned is either in the form of links to retrieve the content, or proprietary order blocks, which are processed by the Content Manager on the client's equipment.

For account status requests, the OMS can request an account-holder record and return the result to the requestor.

Rights locker requests are processed through the Rights Locker Component (RLC). The distributor may request and display the rights locker contents for a given account holder, and request secondary entitlements. An example of a secondary entitlement is a request to restore all rights to a user following a loss of data, for instance due to a hard disk crash. Secondary entitlements are processed by OMS the same as first-time purchases, except that the authorization is provided by the RLC instead of the AMC.

OMS Retail Client Request Flowchart:

FIG. 7C is a flow chart of an exemplary algorithm to perform the OMS fulfillment request function. The OMS Retail Request Processor continuously monitors for entitlement redemptions from end users.

Upon clicking an order link, or as the result of the Content Manager processing an Order Block, entitlements are sent to the OMS. OMS decrypts the entitlement, and checks to ensure that it was issued by OMS. If valid, OMS creates a license using the required DRM product, and returns the result to the user.

OMS Messages and Requests:

The OMS can typically support the following messages and requests:

Catalog Requests: The OMS hands off catalog requests to the Offer Catalog Component (OCC) 102 for delivery, to avoid the uploading of large datasets.

Account Maintenance: The OMS processes account maintenance operations through the AMG/AMC 703.

Subscription Maintenance: The OMS processes account maintenance operations through the AMG/AMC 703.

Purchase Requests: The OMS processes purchase operations through the AMG/AMC 703.

Rights Locker Requests: The OMS processes RLC requests, including side loaded rights from third parties.

Catalog Maintenance: The CLI 101 requests of OCC 102 the creation, update, or deletion of catalog entries.

Catalog Batch Update: CLI 101 requests of OCC 102 the update of a catalog on a batch basis as the result of a packaging operation.

F. Automated Packaging Component (APC)

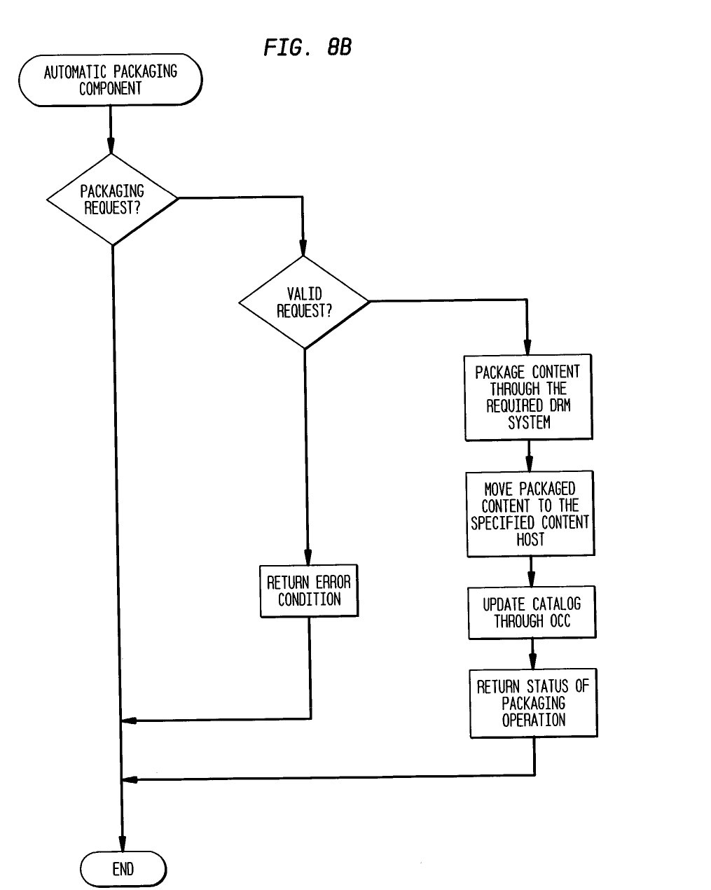

FIG. 8A is a schematic block diagram of an advantageous Automated Packaging Component (APC) 106 in the context of an automatic packaging server. The APC 106 consists of an overall framework, a Digital Rights Management (DRM) abstraction layer, and DRM through-connectors. The APC can support a wide variety of content type, under various business models. Typical examples include: subscription, promotional, direct purchase, or retail-integrated sales. The APC is DRM independent: it interfaces with available DRM technologies and is flexible to work with new technologies as they evolve.

The APC 106 can process commands through the Client Interface (CLI), which receives commands from a content provider or 3rd-party Digital Asset Management (DAM) system. The commands can be in XML format and contain all information necessary to create a content package, including the DRM to be used, the distribution business rules, and any referral URLs. Upon receiving a command, the APC packages the content and places the resulting files on a specified file sharing system. The results (status) of the operation are returned to the outside source via the CLI.

The inputs to the APC 106 are requests for content with packaging instructions, The outputs are the packaged digital product, product information and packaging information, all sent to the OCC 102. The APC is an algorithm in software programmed on a digital computer that acts on requests. It also produces statistics for the OCC 102. The APC is connected to a file sharing system, such as the CLI, the OCC 102 and any other path useful for outputting the packaged digital product to a host.

The APC 106 processes commands from the Web Interface and Gateway component (CLI) 101, which in turn come from a content provider or 3rd-party Digital Asset Management (DAM) 301 system. The commands are typically in XML format, and contain all information necessary to create a content package, including the DRM to be used, super-distribution business rules, and any referral URLs. Upon receiving an XML command, the APC packages the content, placing the resulting files on the specified Content Host 801. The results of the operation are returned to the CLI 101.

APC Flowchart:

FIG. 8B is a flow chart of an exemplary algorithm to perform the APC function. The Automatic Packager Component (APC) monitors for commands in a continuous loop.

Packaging requests are first checked for validity. The content to be packaged must first have been transferred to an APC staging area for processing. If valid, the content is packaged according to the instructions contained in the request. Variables such as the DRM product to use and the business rules to be applied are used in the packaging operation.

The packaged content is moved to a Content Host site specified in the instructions. Next, the OCC notified of the newly available content. Finally, the status of the operation is returned to the requestor.

G. Data Reporting Component (DRC)

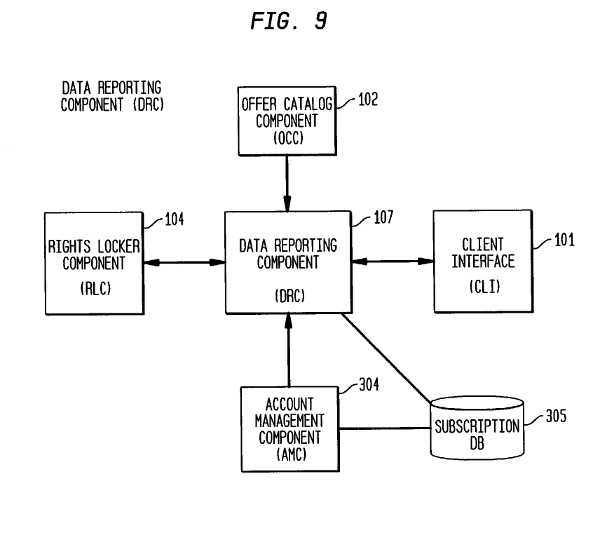

FIG. 9 is a schematic block diagram of a Data Reporting Component (DRC) 107. The DRC 107 generates real-time and custom batch reports for business analysis. For example, the DRC can provide sales figures, content activity, billing, user/download and Rights Locker reports, all in either aggregated, product-specific, or affiliate-specific formats. The DRC is advantageously configured to funnel accounting, billing, payment and other financial reporting to existing systems such as SAP and Oracle Financials.

The DRC 107 is implemented as an abstract interface to a 3rd-party reporting tool, such as Oracle Reports. The abstract interface isolates the implementation details of the tool from the rest of the system, allowing the substitution of other products in the future without affecting other components.

The Client can use a web interface to specify report types to be created, along with any specifics required for those reports. The DRC 107 responds with an XML message containing the resulting report. Typical examples of formats that can be supported are: Excel, comma-delimited ASCII, and XML.

The inputs to the DRC 107 are customer and sales information from the AMC 304, catalog and transactional information from the OCC 102, customer rights grants and usage from the RLC 104, information from the subscriber data base 305, and CLI 101. The DRC is an algorithm in software programmed on a digital computer for generating reports of various types. It makes use of the subscriber data base and information received from the other connected components. The DRC generates custom or preplanned reports by request or by schedule. The output are the reports which can be accessed via the CLI 101.

The DRC advantageously can support following messages and requests:

Report Request: CLI 101 requests a report of the DRC 107; and

Report Maintenance: CLI 101 requests of DRC 107 the creation, update, or deletion of a report type.

H. Additional Preferred System Features

The system can advantageously speed consumer deliveries by detecting (“sniffing”) what DRM technologies the consumer is currently configured to receive. If delivery is not available, or chosen, in a consumer installed DRM technology, the system can prompt the consumer to download the needed DRM component or tool. The sniffer can retrieve system parameters, configuration, and the operating system to assist in making recommendations to the consumer.

Support for a Plurality of Consumer Platforms:

The consumer device which plays a song or sounds an aural book in audio or displays a written work is known as the rendering device. Rendering devices come in many forms, operating in a variety of download environments. The system is truly platform independent, including independence from rendering device type. Here, independence takes on a subtler meaning. It is far more than mere compatibility.

From the consumer's point of view rendering device independence means that once the consumer has purchased rights to a digital work, assuming the purchase plan allows for unrestricted use, the system can log and serve any type of rendering device capable of playing that type of product. In some cases the rendering device itself can accomplish a direct download from the system. In other cases the download is accomplished to consumer computer device such as personal computer, desktop, laptop, or tablet computer, a PDA, or cell phone, and then downloaded to the rendering device. Rendering and download devices can include, but are not limited to, personal computers (PC), laptop PCs (including Apple products), tablet PCs, PocketPCs, personal digital assistants (PDA), encoded media playback devices, such as MP3 players, game consoles, set top boxes, other cable TV appliances, other internet appliances, home stereo, home theater, car stereo, and television. For example, a song can be supplied in any type of currently available format for any song playing device that the consumer owns. In some purchasing arrangements, such universal play rights might be unavailable, but that limitation is a function of the purchase contract and not a technical limitation.

Copyrights are often territorial in effect. The described system can grant these rights in territories as defined by the rights holder or content provider.

Where several consumer platforms are supported, the system can advantageously track the download usage to the various platforms for marketing and advertising reasons. The Rights Locker performs the aforementioned functions as well as to provide proof of purchase to the consumer. The rights locker can also provide a plurality of copies of a purchased digital product according to a “fair use” policy. The fair use policy can be dictated by the digital product content owner or under a different business model, by some other party, as one in the management of the distribution process or even a retailer. Where permission to download multiple copies has been granted, the system can verify and monitor that copies are being downloaded to rendering devices registered to the consumer (private copying).

The system is designed to give easy access to consumers for multiple downloads within a consumer's purchase agreement. It is also capable of detecting consumer violations of purchase agreements and recording such violations. Alternatively, on sensing a download attempt (request) to an unregistered device the system can deny that particular download.

DRM Independence

An important aspect of the invention is the system's independence from a particular type of digital rights management (DRM) scheme. The system can operate with a plurality of DRM types and techniques. The order management system (OMS) similarly is DRM independent as it uses DRMs via a DRM abstraction layer. One way to achieve DRM abstraction is via a messaging system protocol as has been described in this specification.

Conclusion

It can now be seen that the invention is a system for the automated distribution of digital products from one or more clients to one or more consumers. The system comprises one or more digital processors including a plurality of modular software components intercommunicating by a common messaging language.

The modular components of the system include. 1) a client interface (CLI) accessible to the client to allow the client to set up and manage an offer of one or more digital products for sale or subscription; 2) an offer catalog component (OCC) accessible to consumers to provide a listing of the digital products available from the client; 3) an account management system (AMS) to process consumer purchase orders; 4) a rights locker component (RLC) for issuing purchased products and associated rights to consumers, and 5) an order management system (OMS) to coordinate the cataloging of products, the management of accounts and the delivery of products.

The system may also include a modular software automatic packaging component (APC) for packaging digital products for transmission to consumers by providing the products with digital rights management encryption. The system would include one or more digital rights management systems (DRMs) for determining the rights of consumers and/or would permit connection with and use of one or more DRMs of clients. And the system advantageously includes a modular software data reporting component (DRC).

In advantageous embodiments, the CLI receives as inputs from a client, offers of sale of digital products, rules for packaging the content of digital products and rules for subscription to digital products. The CLI communicates the offers of sale to the OCC for updating the list of products available from the client. The CLI communicates the rules for packaging to the APC, and it communicates the rules for subscription to the AMS to create custom subscription plans.

Advantageously, the OCC comprises a content catalog database containing product and offer information for digital products. The database thus provides a real-time listing of digital products available for purchase or subscription. The OCC receives product information from the OMS, looks up the requested product information and returns information to the OMS.

The AMS comprises an account management component (AMC) for storing information about consumer accounts and for creating and administering subscription plans. The AMS advantageously includes an account management gateway (AMG) to provide a gateway for client customized use of the AMC.

Advantageously, the RLC maintains a rights database storing product purchase information and rights granted with the purchases. The RLC receives rights update requests from the OMS, looks up the requested rights update information and returns the information to the OMS. In a specific embodiment, the RLC receives and stores in the rights database the rights granted to each consumer, identification of the consumer, and any deleted rights of the consumer.

The OMS manages communications involving clients, consumers and internal communications of the system. It receives external communications, parses the communications and sends them to system components for processing. The OMS is advantageously an event-driven processor driven by requests from external or internal interfaces. It can include an order management gateway for custom interfacing with clients.

The APC receives commands to package a digital product and the digital rights management to be used. In response, the APC packages the product into a file and places the file on a file sharing system. Advantageously, the APC comprises a modular software digital rights management abstraction layer to interface with the digital rights management systems of clients. Thus the system can include one or more internal digital management systems (DRMs) and/or access one or more DRMs of clients. The DRMs can be applied to a plurality of content types and a plurality of different computer platforms. Advantageously, the system includes a “sniffer” to detect which DRM technologies a consumer device is configured to receive and can install such DRM technologies on the consumers device.

In a preferred embodiment, the system can download a purchased digital, product for playing into any of a plurality of consumer devices including: personal computers, personal digital assistants, set top boxes, mobile telephones, game consoles, car stereo, encoded media playback devices (e.g. MP3 players), tablet personal computers, pocket personal computers, cable television devices, internet appliances, home stereos and television sets.

Downloading can be done through a digital network. Suitable digital networks include, but are not limited to, the internet, cable, wireless local area networks, bluetooth, Infrared (IR), wired networks, and satellite networks.

In another aspect, the invention comprises a method for providing a client with an automated system for distributing digital products to consumers using a system composed of an intercommunicating CLI, OCC, AMS, RLC and OMS on one or more digital processors. The method comprises the steps of providing the system, permitting the client to access the CLI to enable the client to set up and manage the offer of digital products for sale or subscription and presenting to consumers via the OCC a listing of digital products available from the client. The method further comprises processing consumer purchase orders from the client via the AMS, issuing purchased products to consumers via the RLC and coordinating the cataloging of products, the management of accounts and the delivery of products via the OMS. In advantageous embodiments, the method comprises the further steps of encrypting the digital products in accordance with a digital rights management technique and generating reports of sales.

It is understood that the above-described embodiments are illustrative of only a few of the many possible specific embodiments, which can represent applications of the invention. Numerous and varied other arrangements can be made by those skilled in the art without departing from the spirit and scope of the invention.

We claim:

1. A system for the automated distribution of digital products from a client to consumers comprising one or more digital processors including a plurality of modular software components intercommunicating by a common messaging language, the modular components including:
a client interface (CLI) accessible to the client to allow the client to set up and manage an offer of digital products for sale or subscription;
an offer catalog component (OCC) accessible to consumers to provide a listing of the digital products available from the client;
an account management system (AMS) to process consumer purchase orders;
a rights locker component (RLC) for issuing purchased products and associated rights to consumers; and
an order management system (OMS) to coordinate the cataloging of products, the management of accounts and the delivery of products.

2. The system of claim 1 wherein the CLI receives, as inputs from a client, offers of sale of digital products, rules for packaging the content of digital products and rules for subscription to digital products.

3. The system of claim 2 wherein the CLI communicates the offers of sale to the OCC for updating the listing of products available from the client.

4. The system of claim 2 further comprising a modular software automatic packaging component (APC) for packaging digital products for transmission by providing the products with digital rights management encryption.

5. The system of claim 2 wherein the CLI communicates the rules for packaging to the APC.

6. The system of claim 2 wherein the CLI communicates the rules for subscription to the AMS to create custom subscription plans.

7. The system of claim 1 wherein the OCC comprises a content catalog database containing product and offer information for digital products to provide a real-time listing of digital products available for purchase or subscription.

8. The system of claim 1 wherein the OCC receives product information requests from the OMS, looks up the requested product information and returns the information to the OMS.

9. The system of claim 1 wherein the AMS comprises an account management component for storing information about consumer accounts and creating and administering subscription plans.

10. The system of claim 9 wherein the AMS comprises an account management gateway to provide a gateway for client customized use of the account management component.

11. The system of claim 1 wherein the RLC maintains a rights database storing product purchase information and rights granted with the purchases.

12. The system of claim 1 wherein the RLC receives rights update requests from the OMS, looks up the requested rights update information and returns the information to the OMS.

13. The system of claim 11 wherein the RLC receives and stores in the rights database rights granted to each consumer, identification of the consumer, and any deleted rights of the consumer.

14. The system of claim 1 wherein the OMS manages communications involving clients, consumers and internal communications of the system.

15. The system of claim 1 wherein the OMS receives external communications, parses the communications and sends them to system components for processing.

16. The system of claim 1 wherein the OMS comprises an event-driven processor driven by requests from external or internal interfaces.

17. The system of claim 1 wherein the OMS comprises an order management gateway for custom interfacing with clients.

18. The system of claim 4 wherein the APC receives commands to package a digital product and the digital rights management to be used, and, in response, packages the digital product into a file and places the file on a file sharing system.

19. The system of claim 4 wherein the APC comprises modular software digital rights management abstraction layer to interface with digital rights management systems of clients.

20. The system of claim 1 further comprising a modular software data reporting component (DRC) for generating reports for business analysis.

21. The system of claim 1 further comprising one or more digital rights management systems (DRMs) for determining the rights of consumers to digital products.

22. The system of claim 21 wherein the DRMs are applied to a plurality of content types.

23. The system of claim 21 wherein the DRMs are applied to a plurality of computer platforms.

24. The system of claim 21 wherein the system can connect to one or more external client DRMs.

25. The system of claim 21 wherein the OMS can connect to a plurality of DRMs through an abstraction layer.

26. The system of claim 25, wherein the abstraction is achieved by a system messaging protocol.

27. The system of claim 21 further comprising a sniffer to detect which DRM technologies a consumer device is configured to receive.

28. The system of claim 27 wherein the system can install a DRM system to a consumer device.

29. The system of claim 1 wherein the purchased products and associated rights to consumers can be assigned to a plurality of consumer devices.

30. The system of claim 1 wherein the purchased product can be downloaded into and play on a plurality of consumer devices.

31. The system of claim 30 configured to download the purchased product from a digital network selected from the group consisting of the internet, cable, wireless local area networks, bluetooth, Infrared (IR), wired networks, and satellite networks.

32. The system of claim 30 wherein the consumer device is a personal computer.

33. The system of claim 30 wherein the consumer device is a personal digital assistant.

34. The system of claim 30 wherein the consumer device is a set top box.

35. The system of claim 30 wherein the consumer device is a mobile telephone.

36. The system of claim 30 wherein the consumer device is a game console.

37. The system of claim 30 wherein the consumer device is a car stereo.

38. The system of claim 30 wherein the consumer device is an encoded media playback device.

39. The system of claim 38 wherein the encoded media playback device is an mp3 player.

40. The system of claim 30 wherein the consumer device is a tablet personal computer.

41. The system of claim 30 wherein the consumer device is a pocket personal computer.

42. The system of claim 30 wherein the consumer device is a cable TV device.

43. The system of claim 30 wherein the consumer device is an internet appliance.

44. The system of claim 30 wherein the consumer device is a home stereo.

45. The system of claim 30 wherein the consumer device is a home theater system.

46. The system of claim 30 wherein the consumer device is a television.

47. The system of claim 1 wherein the RLC allows the consumer to install a plurality of copies of a digital product according to a fair use policy.

48. The system of claim 47 wherein the fair use policy is determined by a content owner.

49. The system of claim 1 wherein the RLC provides a proof of purchase to the consumer.

50. The system of claim 29 wherein the RLC tracks which consumer device's the consumer loads the digital product into.

51. The system of claim 29 wherein the RLC checks that the consumer device the consumer loads the digital product into is registered to the consumer.

52. The system of claim 29 wherein the RLC records consumer digital product downloads into a consumer device not registered to the consumer.

53. The system of claim 52 wherein the rights locker denies consumer digital product downloads into a consumer device not registered to the consumer.

54. A method for providing a client with an automated system for distributing digital products to consumers by the steps of:
providing the system of claim 1;
permitting the client access to the system client interface component to enable the client to set up and manage the offer of digital products for sale or subscription;
presenting to consumers via the offer catalog component a listing of the digital products available from the client;
processing consumer purchase orders from the client via the account management system;
issuing purchased products to consumers via the rights locker component; and
coordinating the cataloging of products, the management of accounts and the delivery of products via the order management system.

55. The method of claim 54 further comprising the step of encrypting the digital products in accordance with a digital rights management technique.

56. The method of claim 54 further comprising generating reports of sales.
